(19) United States
(12) Patent Application Publication
(10) Pub. No.: US 2010/0128067 A1
(43) Pub. Date: May 27, 2010

(54) AUTOMATIC GAMMA CORRECTION OF INPUT SOURCE CONTENT

(76) Inventor: Bongsun Lee, La Crescenta, CA (US)

Correspondence Address: Robert D. Shedd, Patent Operations;THOMSON Licensing LLC, P.O. Box 5312, Princeton, NJ, 08543-5312, US

(21) Appl. No.: 12/451,861

(22) PCT Filed: Jun. 20, 2007
(86) PCT No.: PCT/US07/14574

§ 371 Date: Dec. 3, 2009

(51) Int. Cl. G09G 5/10

(52) U.S. Cl. 345/690

(57) ABSTRACT

Gamma information extracted from an input source is utilized to correct display gammas. Adjustment of display parameters is performed automatically based on the gamma information and obtained display characterization information. One instance utilizes gamma information such as, for example, gain, offset, and gamma, to automatically determine a corresponding brightness and/or contrast adjustment level of a display. In this manner, the output gamma can be adjusted to substantially match the input gamma.

### TECHNICAL FIELD

The subject matter relates generally to displays, and more particularly to systems and methods for automatically adjusting display gamma information.

### BACKGROUND

The display representation of video often differs from the originating source. The change is generally reflected as different color intensity levels. Many factors can contribute to this, but most of the alteration is due to the characteristics of the display device itself. A conventional method of characterizing a display is to measure areas or “patches” on the display using a specialized and costly device called a spectroradiometer which measures the spectral power distributions of illuminants. For gamma characteristics, a series of patches is measured (this is called a “ramp”—i.e., gray ramp: (Red,Green,Blue)=(0,0,0), (32,32,32), (64,64,64), . . . , (224,224,224), (255,255,255)). After the measurement, a gamma curve can be drawn in a plot, “luminance vs. digital value.” This gamma is used to compensate the mismatch with the input gamma. This is an accurate and reliable method, but it has drawbacks in that it needs an expensive measurement instrument, it's time consuming to measure many patches, it needs substantial user interactions, and it needs to derive the gamma curve from the measurement data.

### SUMMARY

Gamma information extracted from an input source is leveraged to provide corrections to a display gamma. This allows the input source integrity to be substantially maintained during a user's viewing experience. One instance utilizes gamma information such as, for example, gain, offset, and gamma, to determine a corresponding brightness and/or contrast level of a display. In this manner, the output gamma can be adjusted to substantially match the input gamma. The techniques generally provide a less accurate gamma compared to a display measurement method, but don't require expensive measuring tools and/or user interaction to adjust display characteristics.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of an automatic gamma correction system in accordance with an aspect of an embodiment.

FIG. 2 is another block diagram of an automatic gamma correction system in accordance with an aspect of an embodiment.

FIG. 3 is an illustration of example instances of an automatic gamma correction system in accordance with an aspect of an embodiment.

FIG. 4 is an illustration of gain adjustments for a display in accordance with an aspect of an embodiment.

FIG. 5 is an illustration of offset adjustments for a display in accordance with an aspect of an embodiment.

FIG. 6 is a flow diagram of a method of adjusting display parameters in accordance with an aspect of an embodiment.

FIG. 7 is another flow diagram of a method of adjusting display parameters in accordance with an aspect of an embodiment.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to hardware, software, or a combination of hardware and software in execution. For example, a component may be, but is not limited to being, a process running on a processor, a processor, an object, an executable, and/or a microchip and the like. By way of illustration, both an application running on a processor and the processor can be a component. One or more components may reside within a process and a component may be localized on one system and/or distributed between two or more systems. Functions of the various components shown in the figures can be provided through the use of dedicated hardware as well as hardware capable of executing software in association with appropriate software.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

Typically when a creator of content such as video, for example, finalizes their creation, they pay particular attention to the “look” and “feel” of the content. Color hues, intensity levels, and other visual information play an important part in accurately portraying the art to a viewer. However, much of this information can be lost due to alteration of this information by a viewing device such as a display or monitor. The techniques described herein allow a display device to be automatically corrected based on an input source's gamma information. This can be accomplished without user intervention and/or without expensive measuring devices. Since the correction can be implemented in a playback device (e.g., DVD (digital video/versatile disc) player, set top box, computer, etc.), the corrections can be completed transparently to the user—who now enjoys a more accurate representation of the input source content.

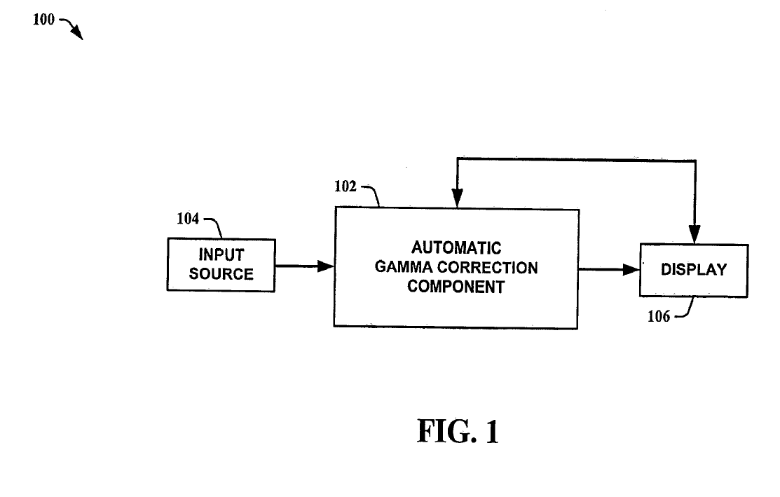

FIG. 1 shows a block diagram of an automatic gamma correction system 100 that utilizes an automatic gamma correction component 102 to process input content gamma information from an input source 104 in order to adjust display parameters of a display 106. The adjustment of the display parameters by the automatic gamma correction component 102 allows the display 106 to more accurately portray the input source content—without requiring user intervention. The input source 104 can be, for example, a digital versatile disc (DVD) player, a set top box, a computer, and/or a broadcast (over air, Internet, intranet, LAN, WAN, etc.) and the like. The automatic gamma correction system can interact with these devices in a wired and/or wireless manner. The display 106 can be, for example, a projector/screen, a computer monitor, a television monitor, and/or a handheld monitor and the like. Similarly, it can be used with display technologies such as, for example, liquid crystal displays (LCDs), plasma, cathode ray tube (CRT), and/or digital light projection (DLP) and the like. The automatic gamma correction system 100 can be utilized to adjust color and/or black and white (gray scale) parameters of the display 106

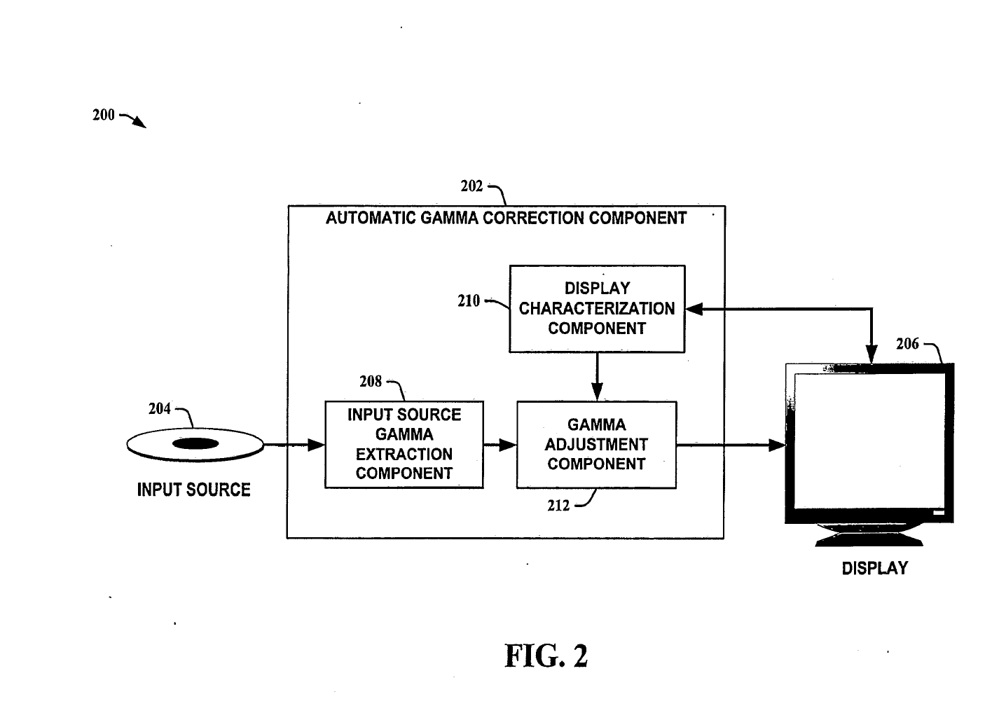

In FIG. 2, an automatic gamma correction system 200 employs an automatic gamma correction component 202 that interfaces with an input source 204 and a display 206. The automatic gamma correction component 202 utilizes an input source gamma extraction component 208 that extracts gamma information from content provided by the input source 204. Often, the gamma information resides as metadata embedded with the content. The automatic gamma correction component 202 can also employ a display characterization component 210 to facilitate in determining and/or acquiring display characterization information. The display characterization component 210 can interface directly with the display 206 to command and/or request its characterization. This can be accomplished, for example, when a playback device is first connected to a display and/or at a later time.

The display characterization component 210 can also obtain display characterization information from other sources such as, for example, lookup tables and the like. The sources of the display characterization information can reside locally and/or remotely to the automatic gamma correction system 200. The automatic gamma correction component 202 utilizes a gamma adjustment component 212 to automatically determine display parameter corrections based on, at least in part, the input source content gamma information and the display characterization information. This can be accomplished, for example, by utilizing functions representative of the display characterization with variables provided by the input source content gamma information. In one instance, this yields gain (contrast) and/or offset (brightness) levels necessary to correct the display for more accurate representations of the input source content.

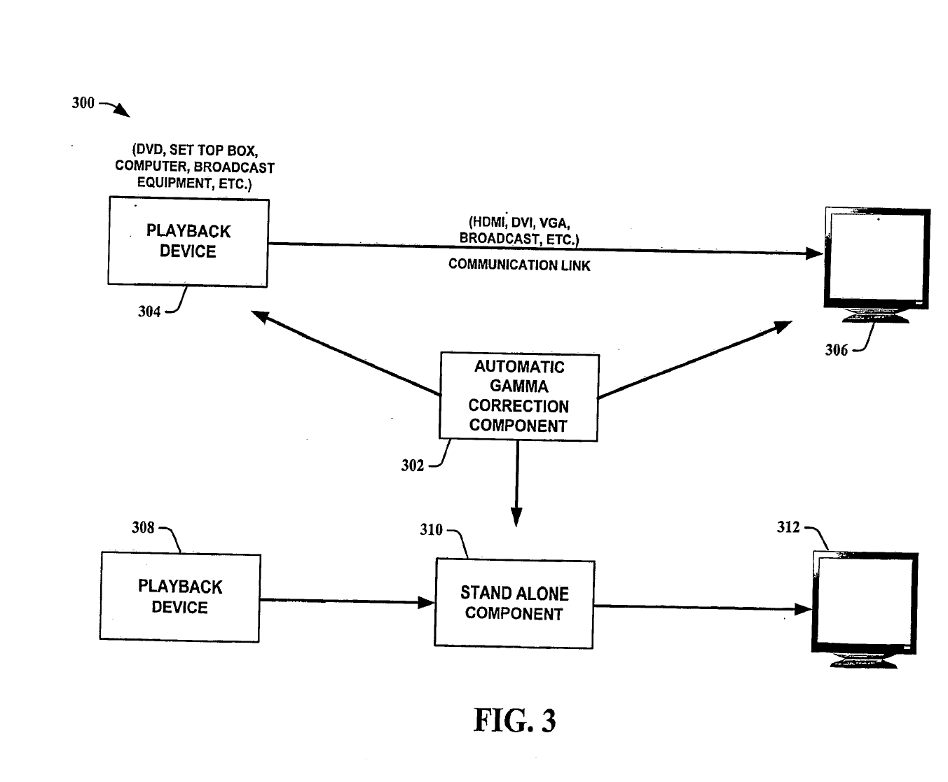

Example instances 300 of an automatic gamma correction system are shown in FIG. 3. For these example instances 300, the automatic gamma correction system is represented by an automatic gamma correction component 302. The automatic gamma correction component 302 can reside, for example, solely in a playback device 304 or solely in display device 306. In other instances, the functionality of the automatic gamma correction component 302 can reside on both the playback device 304 and the display device 306. For example, an input source gamma extraction component 208 can reside within the playback device 304 and send the extracted information to the display device 306 which contains a gamma adjustment component 212 and a display characterization component 210. Similarly, the playback device 304 can contain an input source gamma extraction component 208 and a gamma adjustment component 212 while the display device 306 contains a display characterization component 210 that sends characterization information to the playback device 304.

The playback device 304 and display device 306 are not required to be in proximity of each other. For example, the playback device 304 can encompass broadcasting equipment located at a broadcast facility that communicates over the air and/or via fiber optics/cable with a display device in a user's home. In localized examples, the playback device 304 and display device 306 can be connected via current standardized interfaces such as, for example, HDMI, DVI, and/or VGA interfaces and the like. Likewise, existing and/or future wireless and/or wired standardized and non-standardized interfaces can be utilized as well.

The automatic gamma correction component 302 can also reside in a stand alone component 310 that interacts with a playback device 308 and a display device 312. This instance can allow for minimal changes to legacy devices and still permit automatic adjustment of the display device 312. The stand alone component 310 can be connected wirelessly and/or wired to either the playback device 308 and/or the display device 312. With current standards, the stand alone component 310 can easily extract metadata from content provided by the playback device 308. However, most currently designed display devices do not support external control of display parameters. Similarly, most display devices do not have a means to communicate their display characteristics. Thus, display device interface changes may be necessary to execute the functionality of an automatic gamma correction system, regardless of its location (stand alone, playback device, display device, etc.).

The techniques described herein (including systems, methods, apparatus, etc.) allow the brightness and contrast level of a display to be automatically adjusted so that the display can show more precisely gamma corrected video sequences and/or images. Input source images typically assume certain gamma characteristics of a display. However, most displays exhibit a different gamma causing input images to not be correctly presented on the display. Thus, the presented techniques provide automated gamma correction which can control and/or set the brightness and/or contrast level of a display so that the display gamma is substantially similar to the input source gamma.

For example, digital video capture images or still camera capture images are gamma corrected assuming certain gamma characteristic of display systems. For high definition (HD) displays, Rec.709 gamma is applied for the gamma correction for the input device or input images. For showing film-look images on the display, a proprietary gamma (either a gamma power function curve or lookup table (LUT)) is used for the gamma correction. However, the gamma characteristic of the displays usually does not match with the assumed gamma applied in the input space. Techniques provided herein extract gamma information (gain, offset, gamma) from an input source (information is typically embedded with the input content as a metadata). The corresponding brightness and/or contrast level of the display is then determined so that the output gamma is substantially similar to the input gamma.

For example, a playback device can read the input source images along with metadata which contains gamma characteristics of the input content. At the time the display plugs into the playback device, the playback checks whether the display has been characterized. If not, the playback device can ask the display to go into a characterization mode. The playback device then determines the appropriate brightness and/or contrast level according to the extracted input gamma characteristics and sends a command signal to the display to set its brightness and/or contrast level to the determined level.

A typical gamma formula for a display is shown in (Eq. 1).

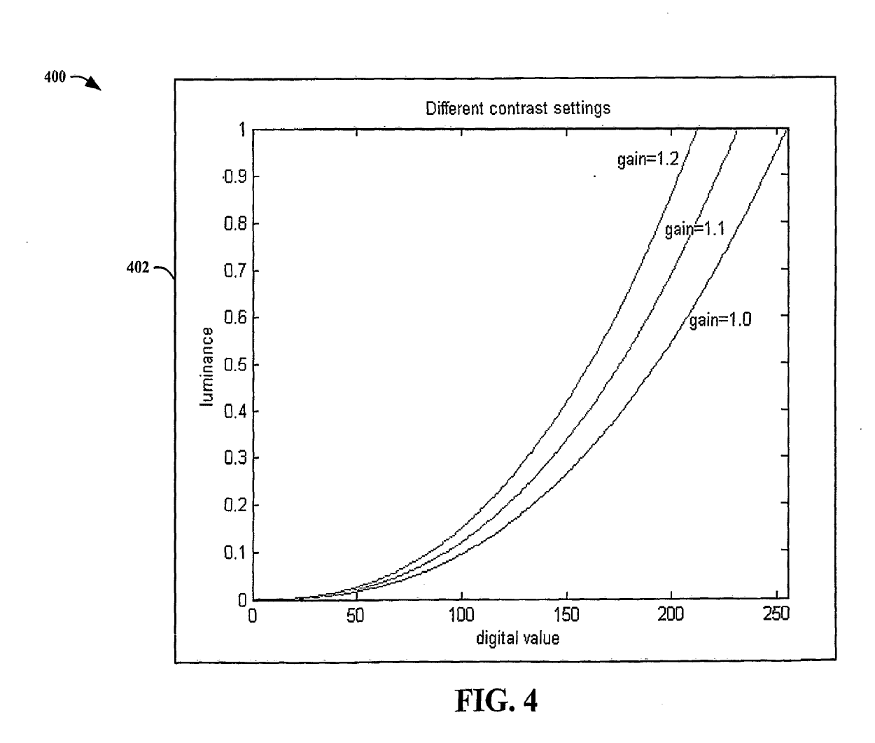

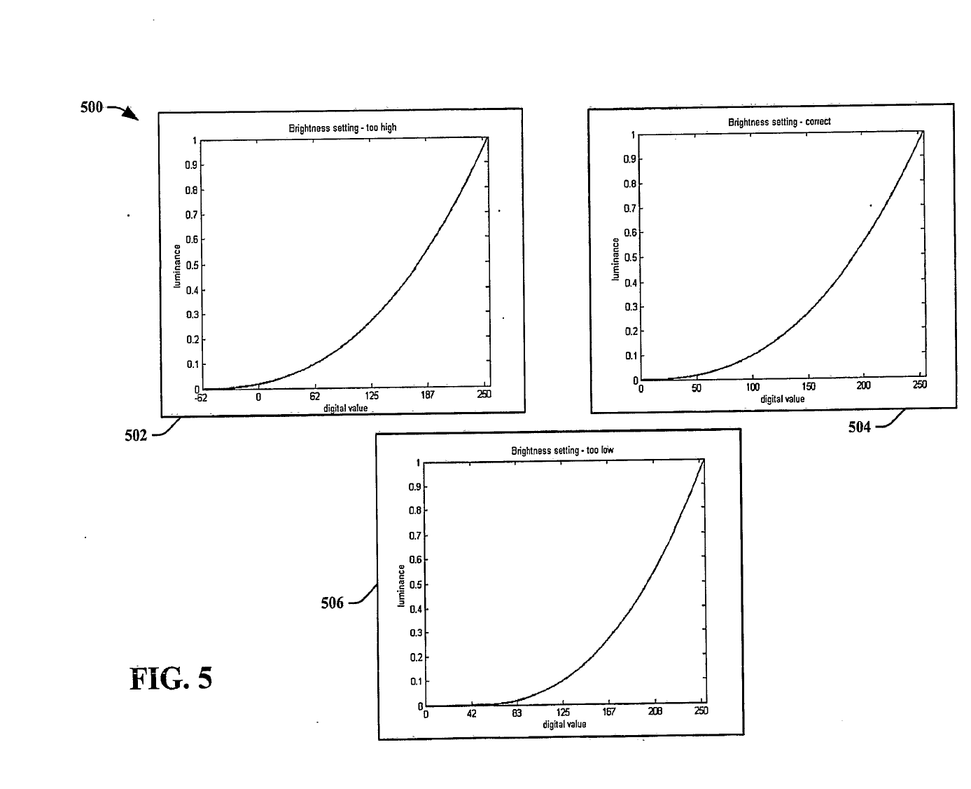

L=(a*(D/255)+b)^{γ} (Eq. 1)

where D is the input digital values (or video signal), a is a gain, b is an offset, γ is a gamma, and L is a luminance of a display. For Rec.709, a=1/1.099, b=0.099, γ=1/0.45. The gain a is varied according to the contrast level of a display. FIG. 4 is an illustration 400 of gain adjustments 402 for a display. Higher contrast increases the value of the gain. The offset is also varied according to the brightness level. FIG. 5 is an illustration 500 of offset adjustments 502-506 for a display. The offset changes with different brightness settings. If the brightness is set to ‘too high’ (negative offset 502), the black (digital value=0) is sliding toward white (digital value=255), hence the luminance of the black will be increased to make the display suffer the decrease of the contrast ratio. ‘Too low’ brightness setting (positive offset (see 506)) causes the input range around the black (e.g., digital value=0-42, (see 506)) to appear completely dark which means the loss of detail information in shadow area. There is also a gamma change relating to the change of the brightness and the contrast levels. Especially, as the brightness is set high 502, the effective gamma is decreased (e.g. γ=2.5 to γ=2.3). If the brightness is set low like 506, then the effective gamma is increased (e.g. γ=2.5 to γ=2.7). 504 illustrates a correct brightness setting.

The techniques provided herein extract the information such as the gain, offset, and the gamma from the input content, and then find the corresponding level of the brightness and/or the contrast to perform the appropriate gamma correction on the output to the display. The gain a (together with the gamma) determines the contrast level and the offset b (together with the gamma) determines the brightness level. To this end, the relationship between the value a and the contrast level is established first. The same identification is performed for the value b vs. the brightness level. As illustrated in FIGS. 4 and 5, the relationship is expected to be linear or at least can be described by one single function. In other words, it can be described by (Eq. 2):

a=f₁(C), b=f₂(B) (Eq. 2)

where a, b are the gain and the offset, respectively, and C and B are the contrast and the brightness level, respectively, and f₁ and f₂ are one-to-one mapping functions describing the relationship, respectively. Then, if a and b (and γ) are found, then the corresponding levels C and B can be determined using the inverse function of f₁ and f₂.

The advantages of these techniques is that they provide means of correction without any measurement instrument, means of setting the display gamma tailored to the input gamma, and means of providing easier and quicker correction method without any intervention of human operators. In one instance, it can be assumed that the gamma curves for three channels (red, green, blue) are the same or very similar and, thus, the correction can be accomplished with a single equation (Eq. 1). However, for displays with different gammas for different channels, the techniques can be extended to each color channel (R, G, B) using a different equation per color.

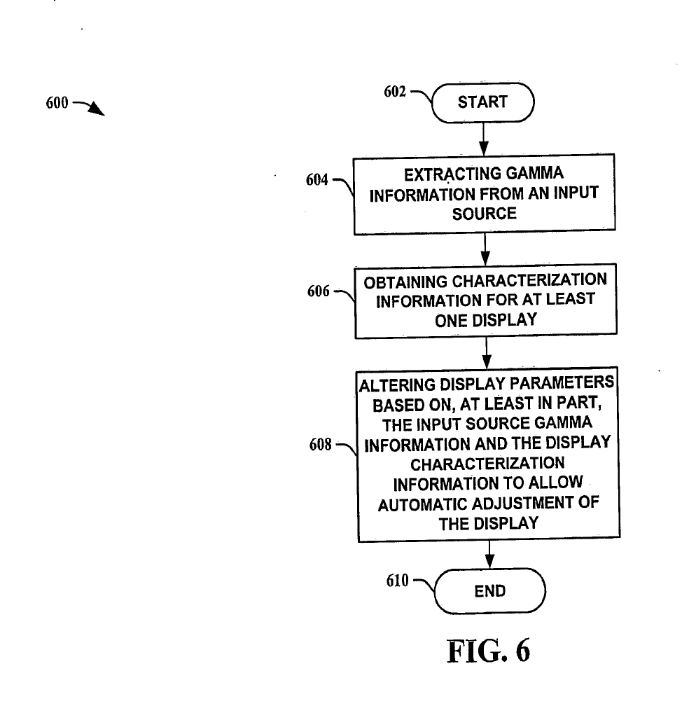

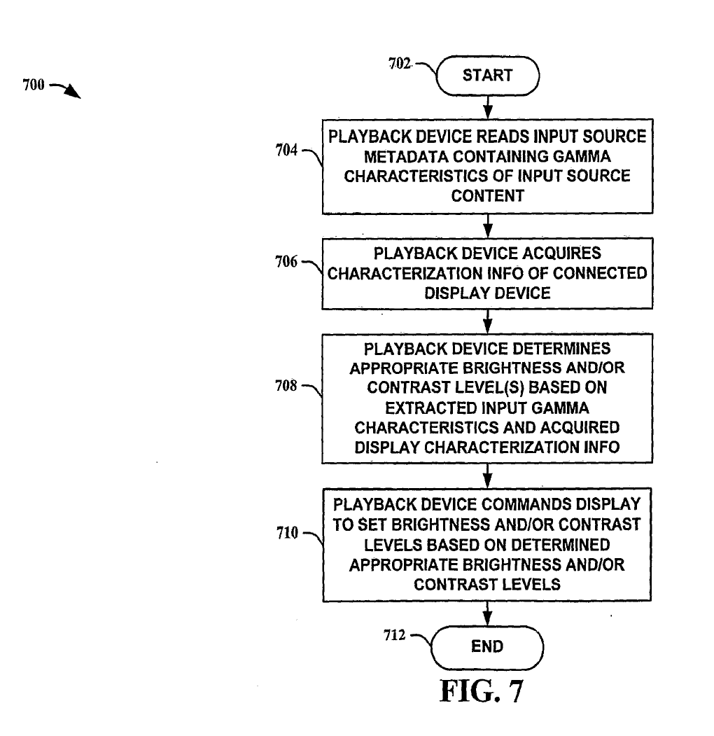

In view of the exemplary systems shown and described above, methodologies that may be implemented in accordance with the embodiments will be better appreciated with reference to the flow charts of FIGS. 6 and 7. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

In FIG. 6, a flow diagram of a method 600 of adjusting display parameters in accordance with an aspect of an embodiment is shown. The method 600 starts 602 by extracting gamma information from an input source 604. For example, the gamma information can be embedded into source content as metadata which can then be extracted from the source content. Characterization information is then obtained for at least one display 606. The information can be obtained directly from a display and/or from other means such as, for example, lookup tables and/or other resources, both local and/or remote. Display parameters are altered based on, at least in part, the input source gamma information and the display characterization information to allow automatic adjustment of the display 608, ending the flow 610. A single equation can be utilized for all color channels and/or different equations can be used for each color channel.

Looking at FIG. 7, another flow diagram of a method 700 of adjusting display parameters in accordance with an aspect of an embodiment is illustrated. The method 700 starts 702 with a playback device reading input source metadata containing gamma characteristics of input source content 704. The playback device can be, for example, a device in proximity of a display device such as a set top box, DVD player, stand alone box, etc. The playback device can also include broadcasting equipment that is typically remote to the display device. The playback device acquires characterization information of a connected display device 706. The characterization information can come directly from the display device and/or from a pre-existing resource and described supra. The playback device then determines appropriate brightness and/or contrast level(s) based on the extracted input gamma characteristics and the acquired display characterization information 708. This can be accomplished with a single determination technique and/or with a determination technique for each color channel and the like. The playback device commands the display to set brightness and/or contrast levels based on the determined appropriate brightness and/or contrast levels 710, ending the flow 712. The command can be done directly to the display device and/or through content supplied to the display device (embedded display parameter corrections/commands, etc.).

In one instance, a data packet transmitted between two or more devices that facilitates display adjustment is comprised of, at least in part, information relating to an automatic gamma adjustment system that utilizes, at least in part, input source gamma information and display characterizations to automatically adjust gain and offset of a display.

It is to be appreciated that the systems and/or methods of the embodiments can be utilized in gamma correction facilitating computer components and non-computer related components alike. Further, those skilled in the art will recognize that the systems and/or methods of the embodiments are employable in a vast array of electronic related technologies, including, but not limited to, computers, video playback devices, set top boxes, displays and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that adjusts gamma information, comprising:
an extraction component that obtains gamma information from at least one media source;
a characterization component that retrieves display characterizations of at least one display; and
a gamma component that adjusts display parameters based on, at least in part, the media source gamma information and the display characterizations.

2. The system of claim 1, wherein the characterization component retrieves the display characterizations directly from a display.

3. The system of claim 1, wherein the characterization component retrieves the display characterizations from a local and/or remotely stored lookup table.

4. The system of claim 1, wherein the gamma component resides within a playback device.

5. The system of claim 1, wherein the gamma component resides within a display device.

6. The system of claim 1, wherein the gamma component interfaces between a playback device and a display.

7. The system of claim 1, wherein the gamma component adjusts gain and offset of the display parameters based on a predetermined function associated with a particular display.

8. A method for adjusting gamma information, comprising:
extracting gamma information from an input source;
obtaining characterization information for at least one display; and
altering the display parameters based on, at least in part, the input source gamma information and the display characterization information, allowing automatic adjustment of the display.

9. The method of claim 8 further comprising:
automatically adjusting gamma information of at least one display via a playback device that reads an input source and transmits video to a display.

10. The method of claim 9 further comprising:
acquiring characterization information of the display via the playback device when the display is initially connected to the playback device.

11. The method of claim 9 further comprising:
acquiring characterization information of the display via the playback device by commanding the display into a characterization mode.

12. The method of claim 8 further comprising:
altering the display parameters for each red-blue-green (RGB) component of the input source.

13. A system that adjusts gamma information, comprising:
means for obtaining gamma information from an input source; and
means for automatically adjusting display parameters based on, at least in part, the input source gamma information and display characterization information.

14. A data packet, transmitted between two or more devices, that facilitates display adjustment, the data packet comprising, at least in part, information relating to an automatic gamma adjustment system that utilizes, at least in part, input source gamma information and display characterizations to automatically adjust gain and offset of a display.

15. A computer readable medium having stored thereon computer executable components of the system of claim 1.

16. A device employing the method of claim 8 comprising at least one selected from the group consisting of a computer, a video playback device, a set top boxes, a display and/or a handheld electronic device.

17. A device employing the system of claim 1 comprising at least one selected from the group consisting of a computer, a video playback device, a set top boxes, a display and/or a handheld electronic device.

18. A display device that accepts video/images and external gamma controls based on, at least in part, the video/images.

19. A playback device that outputs video/images and display gamma controls associated with the video/images.

20. A gamma control device interposed between a playback device and a display device that extracts gamma information from video/images from the playback device and outputs gamma control information to the display device, the gamma control information based on, at least in part, the video/images.
